(19) United States
(12) Patent Application Publication
(10) Pub. No.: US 2024/0349288 A1
(43) Pub. Date: Oct. 17, 2024

(54) METHOD AND DEVICE USED FOR WIRELESS COMMUNICATION

(71) Applicants: Jinfang ZHANG, Shanghai (CN); Xiaobo ZHANG, Shanghai (CN)

(72) Inventors: Jinfang ZHANG, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/636,271

(22) Filed: Apr. 16, 2024

(30) Foreign Application Priority Data
Apr. 17, 2023 (CN) 202310409978.2

(51) Int. Cl. H04W 72/21; H04W 72/1268

(52) U.S. Cl. CPC H04W 72/21; H04W 72/1268

(57) ABSTRACT

The present application provides a method and device for wireless communications. A first node receives a first signaling, the first signaling is used to configure uplink grant, the uplink grant configured by the first signaling comprises a first uplink grant and a second uplink grant, the first uplink grant is available for a UCI, the UCI corresponding to the first uplink grant is used to determine whether at least the second uplink grant is not performed; performs uplink transmission according to a configuration of the first signaling; wherein whether the uplink transmission occupies a PUSCH corresponding to the second uplink grant depends on whether a PUSCH corresponding to the first uplink grant is transmitted. The present application can effectively improve the uplink transmission performance.

### CROSS REFERENCE TO RELATED APPLICATIONS

The present application claims the priority benefit of Chinese Patent Application No. 202310409978.2, filed on Apr. 17, 2023, the full disclosure of which is incorporated herein by reference.

### BACKGROUND

### Technical Field

The present application relates to methods and devices in wireless communication systems, and in particular to a method and a device for supporting non-dynamically scheduled uplink transmissions in wireless communications.

### Related Art

Application scenarios of future wireless communication systems are becoming increasingly diversified, and different application scenarios have different performance demands on systems. In order to meet different performance requirements of various application scenarios, it was decided at 3rd Generation Partner Project (3GPP) Radio Access Network (RAN) #72th plenary that a study on New Radio (NR), or what is called Fifth Generation (5G) shall be conducted. The work item of NR was approved at 3GPP RAN #75th plenary to standardize NR.

The uplink transmission based on non-dynamic scheduling consists of configured grant type 1 and configured grant type 2, where an uplink grant in configured grant type 1 is provided and activated by RRC (Radio Resource Control); a cycle in configured grant type 2 is provided by RRC, and activating/de-activating an uplink grant is implemented by L1 (Layer 1)/L2 (Layer 2) control signaling.

Enhancement of uplink transmission based on non-dynamic scheduling is an important aspect for improving the performance of wireless communication systems in NR technology.

### SUMMARY

Inventors have found through researches that the impact of a relation between a PUSCH (Physical uplink shared channel) and UCI (Uplink control information) on scheduling in uplink transmission is an important issue to be considered. To address the above problem, the present application provides a solution. And the embodiments in the present application and the characteristics in the embodiments can be arbitrarily combined if there is no conflict. Though originally targeted at Uu air interface, the present application is also applicable to PC5 interface. Besides, the present application is not only targeted at scenarios of terminals and base stations, but also at to Vehicle-to-Everything (V2X) scenarios, terminals and relays as well as communication scenarios between relays and base stations, where similar technical effects can be achieved. The present application can be applied to a variety of wireless communication scenarios, such as eMBB (Enhanced Mobile Broadband), XR (extended reality), URLLC (Ultra-Reliable Low-Latency Communications), IoVs (Internet of Vehicles), IoTs (Internet of Things), NTN (Non-Terrestrial Networks), eMTC (Enhanced Machine-Type Communication), etc., where similar technical effects can be achieved. Additionally, the adoption of a unified solution for various scenarios, including but not limited to V2X scenarios and communication scenarios between terminals and base stations, contributes to the reduction of hardware complexity and costs. Particularly, for interpretations of the terminology, nouns, functions and variants (if not specified) in the present application, refer to definitions given in TS36 series, TS38 series and TS37 series of 3GPP specifications.

The present application provides a method in a first node for wireless communications, comprising:
receiving a first signaling, the first signaling being used to configure an uplink grant, the uplink grant configured by the first signaling comprising a first uplink grant and a second uplink grant, the first uplink grant being available for a UCI, the UCI corresponding to the first uplink grant being used to determine whether at least the second uplink grant is not performed; and
performing uplink transmission according to the configuration of the first signaling;
herein, whether the uplink transmission occupies a PUSCH corresponding to the second uplink grant depends on whether a PUSCH corresponding to the first uplink grant is transmitted.

In one embodiment, the first signaling configures a scenario of multiple uplink grants.

In one embodiment, the uplink grant is a configured uplink grant.

In one embodiment, the present application is particularly applicable to shared spectrum scenarios.

In one embodiment, the above method can improve the uplink transmission performance by indicating whether at least one uplink grant is not performed through UCI.

In one embodiment, a problem to be solved in the present application is: how to process a second uplink grant when a PUSCH corresponding to a first uplink grant is not transmitted.

In one embodiment, the above method provides the system implementation flexibility.

According to one aspect of the present application, comprising:
whether the uplink transmission occupies a PUSCH corresponding to the second uplink grant depends on whether a PUSCH corresponding to a third uplink grant is transmitted, the third uplink grant is available for a UCI, and a UCI corresponding to the third uplink grant is used to determine whether at least the second uplink grant is not performed; the first uplink grant, the third uplink grant and the second uplink grant are configured by a same configured grant configuration, and the first signaling comprises the same configured grant configuration.

In one embodiment, the above method improves the UCI transmission robustness.

In one embodiment, the above method improves the uplink transmission performance.

According to one aspect of the present application, comprising:
the PUSCH corresponding to the first uplink grant is transmitted, and a PUSCH corresponding to the third uplink grant does not carry a UCI.

In one embodiment, the above method saves the signaling overhead.

According to one aspect of the present application, comprising:
receiving a second signaling, the second signaling indicating that the PUSCH corresponding to the first uplink grant is successfully received;
herein, the PUSCH corresponding to the first uplink grant is transmitted; the PUSCH corresponding to the third uplink grant does not carry a UCI.

In one embodiment, when the PUSCH corresponding to the first uplink grant is successfully received, it may be determined that UCI carried by the PUSCH corresponding to the first uplink grant is successfully received.

In one embodiment, the above method gains the benefits of saving the signaling overhead and improving the transmission robustness of UCI at the same time.

According to one aspect of the present application, comprising:
a PUSCH corresponding to the first uplink grant is not transmitted, and a PUSCH corresponding to the second uplink grant is available for the uplink transmission.

In one embodiment, the above method is simple and effective.

In one embodiment, the above method avoids/mitigates the negative impact of inconsistent information between the base station and the UE brought about by the fact that a PUSCH corresponding to the first uplink grant is not transmitted.

According to one aspect of the present application, comprising:
a PUSCH corresponding to the first uplink grant is transmitted, and whether the uplink transmission occupies a PUSCH corresponding to the second uplink grant is at least dependent on the UCI corresponding to the first uplink grant.

In one embodiment, the above method improves the uplink transmission performance through UCI. According to one aspect of the present application, comprising:
receiving a first indication from a lower layer of the first node, the first indication being used to determine that a PUSCH corresponding to the first uplink grant is not transmitted.

In one embodiment, the above method can mitigate possible transmission collisions.

The present application provides a method in a second node for wireless communications, comprising:
transmitting a first signaling, the first signaling being used to configure an uplink grant, the uplink grant configured by the first signaling comprising a first uplink grant and a second uplink grant, the first uplink grant being available for a UCI, the UCI corresponding to the first uplink grant being used to determine whether at least the second uplink grant is not performed; and
performing an uplink reception according to a configuration of the first signaling;
herein, whether the uplink reception comprises a PUSCH corresponding to the second uplink grant depends on whether a PUSCH corresponding to the first uplink grant is received.

According to one aspect of the present application, comprising:
whether the uplink reception comprises a PUSCH corresponding to the second uplink grant depends on whether a PUSCH corresponding to a third uplink grant is received, the third uplink grant is available to UCI, a UCI corresponding to the third uplink grant is used to determine whether at least the second uplink grant is not performed; the first uplink grant, the third uplink grant and the second uplink grant are configured by a same configured grant configuration, and the first signaling comprises the same configured grant configuration.

According to one aspect of the present application, comprising:
the PUSCH corresponding to the first uplink grant is received, and a PUSCH corresponding to the third uplink grant does not carry a UCI.

According to one aspect of the present application, comprising:
transmitting a second signaling, the second signaling indicating that the PUSCH corresponding to the first uplink grant is successfully received;
herein, the PUSCH corresponding to the first uplink grant is received; the PUSCH corresponding to the third uplink grant does not carry a UCI.

According to one aspect of the present application, comprising:
a PUSCH corresponding to the first uplink grant is not received, and a PUSCH corresponding to the second uplink grant is available for the uplink reception.

In one embodiment, the uplink reception comprises a reception of a PUSCH corresponding to the second uplink grant.

According to one aspect of the present application, comprising:
a PUSCH corresponding to the first uplink grant is received, and whether the uplink reception comprises a PUSCH corresponding to the second uplink grant is at least dependent on the UCI corresponding to the first uplink grant.

According to one aspect of the present application, comprising:
a receiver of the first signaling receiving a first indication from a lower layer, the first indication being used to determine that a PUSCH corresponding to the first uplink grant is not transmitted.

The present application provides a first node for wireless communications, comprising:
a first receiver, receiving a first signaling, the first signaling being used to configure an uplink grant, the uplink grant configured by the first signaling comprising a first uplink grant and a second uplink grant, the first uplink grant being available for a UCI, the UCI corresponding to the first uplink grant being used to determine whether at least the second uplink grant is not performed; and
a first transmitter, performing uplink transmission according to the configuration of the first signaling;
herein, whether the uplink transmission occupies a PUSCH corresponding to the second uplink grant depends on whether a PUSCH corresponding to the first uplink grant is transmitted.

The present application provides a second node for wireless communications, comprising:
a second transmitter, transmitting a first signaling, the first signaling being used to configure an uplink grant, the uplink grant configured by the first signaling comprising a first uplink grant and a second uplink grant, the first uplink grant being available for a UCI, the UCI corresponding to the first uplink grant being used to determine whether at least the second uplink grant is not performed; and
a second receiver, performing an uplink reception according to a configuration of the first signaling;
herein, whether the uplink reception comprises a PUSCH corresponding to the second uplink grant depends on whether a PUSCH corresponding to the first uplink grant is received.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of the processing of a signal in a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of hardware modules of a communication device according to one embodiment of the present application;

FIG. 5 illustrates a flowchart of radio signal transmission according to one embodiment of the present application;

FIG. 6 illustrates a flowchart of a radio signal transmission according to one embodiment of the present application;

FIG. 7 illustrates a flowchart of the processing of a signal in a first node according to one embodiment of the present application;

FIG. 8 illustrates a flowchart of the processing of a signal in a first node according to one embodiment of the present application;

FIG. 9 illustrates a schematic diagram of an uplink grant of a first signaling configuration according to one embodiment of the present application;

FIG. 10 illustrates a schematic diagram of a first uplink grant and a second uplink grant according to one embodiment of the present application;

FIG. 11 illustrates a schematic diagram of a first uplink grant, a third uplink grant and a second uplink grant according to one embodiment of the present application;

FIG. 12 illustrates a schematic diagram of a relation between a PUSCH corresponding to a first uplink grant and UCI according to one embodiment of the present application;

FIG. 13 illustrates a structure block diagram of a processor in a first node according to one embodiment of the present application;

FIG. 14 illustrates a structure block diagram of a processor in second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

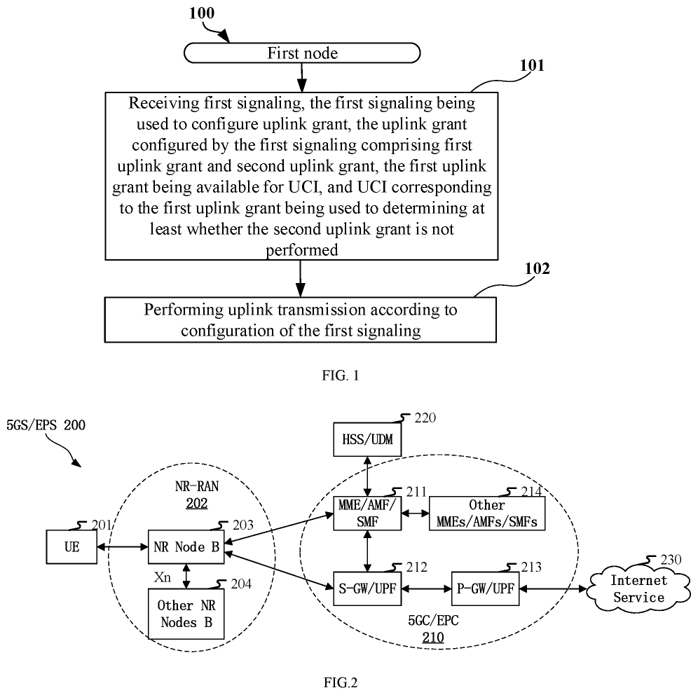

Embodiment 1 illustrates a flowchart of the processing of a signal in a first node according to one embodiment of the present application, as shown in FIG. 1.

In embodiment 1, a first node 100 receives a first signaling in step 101, the first signaling is used to configure an uplink grant, the uplink grant configured by the first signaling comprises a first uplink grant and a second uplink grant, the first uplink grant is available for a UCI, the UCI corresponding to the first uplink grant is used to determine whether at least the second uplink grant is not performed; performs an uplink transmission according to a configuration of the first signaling in step 102; herein, whether the uplink transmission occupies a PUSCH corresponding to the second uplink grant depends on whether a PUSCH corresponding to the first uplink grant is transmitted.

In one embodiment, a first signaling is received.

In one embodiment, the first signaling is a higher-layer signaling.

In one embodiment, the first signaling is an RRC signaling.

In one embodiment, the first signaling comprises at least one Information Element (IE) in an RRC signaling.

In one embodiment, the first signaling comprises at least one field of an information element in an RRC signaling.

In one embodiment, the first signaling is ConfiguredGrantConfig.

In one embodiment, the first signaling comprises at least one field in ConfiguredGrantConfig.

In one embodiment, the first signaling is used to configure a configured grant configuration, and the configured grant configuration indicates configured grant type 1.

In one embodiment, the first signaling indicates a periodic time-frequency resource set.

In one embodiment, the periodic time-frequency resource set is periodic time-frequency resource set in time domain.

In one embodiment, the first signaling indicates a start time for the periodic time-frequency resource set.

In one embodiment, the first signaling indicates frequency-domain resources in the periodic time-frequency resource set.

In one embodiment, the first signaling indicates a period of an occurrence of the periodic time-frequency resource set.

In one embodiment, the first signaling indicates a time-domain location and a frequency-domain location of the periodic time-frequency resource set in a time-domain cycle.

In one embodiment, the first signaling comprises a first sub-signaling and a second sub-signaling; herein, the first sub-signaling is an RRC signaling, and a second sub-signaling is a layer-1 signaling.

In one embodiment, the first sub-signaling is used to configure a configured grant configuration and the second sub-signaling is used to activate the configured grant configuration; herein, the configured grant configuration indicates configured grant type 2.

In one embodiment, the first sub-signaling is used to configure a period value of a configured grant; the second sub-signaling indicates a time-frequency resource set, the time-frequency resource set occurring periodically at a time interval indicated by the period of the configured grant.

In one embodiment, the second sub-signaling is a signaling in a PDCCH (Physical downlink control channel).

In one embodiment, the second sub-signaling is Downlink control information (DCI).

In one embodiment, the second sub-signaling is a valid activation DCI.

In one embodiment, a CRC (Cyclic redundancy check) of the second sub-signaling is scrambled by a CS-RNTI (Configured Scheduling-Radio Network Temporary Identifier).

In one embodiment, the first signaling is a PDCCH.

In one embodiment, the first signaling is DCI.

In one embodiment, the first signaling is used to configure an uplink grant.

In one embodiment, the meaning of the expression that the first signaling is used to configure an uplink grant is: the first signaling is used to provide an uplink grant.

In one embodiment, the meaning of the expression that the first signaling is used to configure an uplink grant is: the first signaling is used to indicate configuration information for an uplink grant.

In one embodiment, the uplink grant is a configured uplink grant.

In one embodiment, the uplink grant occurs periodically.

In one embodiment, the uplink grant is performed periodically.

In one embodiment, the uplink grant is performed after being activated and before being de-activated.

In one embodiment, the uplink grant sequentially occurs.

In one embodiment, the meaning of an uplink grant being executed is: an uplink transmission occupies a PUSCH corresponding to an uplink grant.

In one embodiment, the meaning of an uplink grant being executed is: a PUSCH corresponding to an uplink grant is transmitted.

In one embodiment, the meaning of an uplink grant being executed is: time-frequency resources indicated by an uplink grant are used for a PUSCH transmission corresponding to the uplink grant.

In one embodiment, the meaning of an uplink grant being executed is: a PUSCH transmission occasion corresponding to an uplink grant is used.

In one embodiment, the uplink grant configured by the first signaling comprises a first uplink grant and a second uplink grant.

In one embodiment, the first signaling indicates a periodic uplink grant, and the periodic uplink grant comprises the first uplink grant and the second uplink grant.

In one embodiment, the uplink grant configured by the first signaling is stored as a configured uplink grant.

In one embodiment, the uplink grant configured by the first signaling is configured by a same configured grant configuration.

In one embodiment, the first uplink grant is available for a UCI.

In one embodiment, the first uplink grant being available for a UCI comprises: at least partial time-frequency resources indicated by the first uplink grant is reserved for a UCI.

In one embodiment, the first uplink grant being available for a UI comprises: at least partial time-frequency resources indicated by the first uplink grant is used for UCI transmission.

In one embodiment, the first uplink grant being available for a UCI comprises: a PUSCH corresponding to the first uplink grant is available for a UCI.

In one embodiment, the first uplink grant being available for a UCI comprises: a PUSCH corresponding to the first uplink grant carries a UCI.

In one embodiment, the first uplink grant being available for a UCI comprises: a UCI is multiplexed onto a PUSCH corresponding to the first uplink grant.

In one embodiment, the meaning of a PUSCH carrying a UCI is: UCI is multiplexed onto a PUSCH.

In one embodiment, the meaning of a PUSCH carrying UCI is: UCI is transmitted via a PUSCH.

In one embodiment, a UCI corresponding to the first uplink grant is used to determine whether at least the second uplink grant is not performed.

In one embodiment, a UCI carried by a PUSCH corresponding to the first uplink grant is used to determine whether at least the second uplink grant is not performed.

In one embodiment, a UCI corresponding to the first uplink grant is used to determine that the second uplink grant is not performed.

In one embodiment, a UCI corresponding to the first uplink grant is used to determine that the second uplink grant is performed.

In one embodiment, a UCI is used to determine continuous uplink grants that are not performed.

In one subembodiment of the above embodiment, a UCI provides a PUSCH transmission occasion corresponding to continuous uplink grants in time domain.

In one subembodiment of the above embodiment, a UCI provides a duration or range of PUSCH transmission occasion corresponding to continuous uplink grants in time domain.

In one embodiment, a UCI is used to determine continuous or discontinuous uplink grants that are not performed.

In one embodiment, a UCI provides a bitmap, each bit in the bitmap corresponding to a PUSCH transmission occasion corresponding to an uplink grant within a time interval/range, and the bit indicates whether the uplink grant is not performed.

In one embodiment, a UCI provides a bitmap, where each bit in the bitmap corresponds to a PUSCH transmission occasion for multiple uplink grants within a time interval/range, and the bit indicates whether the multiple uplink grants within the time interval/range are not executed.

In one embodiment, a UCI being used to determine whether an uplink grant is not performed comprises: a UCI is used to determine whether an uplink grant is not performed.

In one embodiment, when a UCI corresponding to the first uplink grant indicates the second uplink grant, the second uplink grant is not performed.

In one embodiment, when a UCI corresponding to the first uplink grant does not indicate the second uplink grant, the second uplink grant is performed.

In one embodiment, a UCI being used to determine whether an uplink grant is not performed comprises: a UCI is used to determine that an uplink grant is performed, or, a UCI is used to determine that an uplink grant is not performed.

In one embodiment, when a UCI corresponding to the first uplink grant indicates the second uplink grant is not performed, the second uplink grant is not performed.

In one embodiment, when a UCI corresponding to the first uplink grant indicates the second uplink grant is performed, the second uplink grant is performed.

In one embodiment, an uplink transmission is performed according to a configuration of the first signaling.

In one embodiment, the meaning that an uplink transmission is performed according to a configuration of the first signaling is: performing an uplink transmission on an uplink grant configured by the first signaling.

In one embodiment, the meaning that an uplink transmission is performed according to a configuration of the first signaling is: determining whether to perform an uplink transmission on an uplink grant configured by the first signaling; when it is determined to perform an uplink transmission, transmitting a PUSCH; when it is determined to not perform an uplink transmission, dropping transmitting a PUSCH;

In one embodiment, executing the uplink transmission is transmitting a PUSCH.

In one embodiment, the meaning of transmitting a PUSCH is: transmitting information in a PUSCH.

In one embodiment, the meaning of transmitting a PUSCH is: transmitting a radio signal through a PUSCH.

In one embodiment, the PUSCH is a CG (Configured Grant) PUSCH.

In one embodiment, the PUSCH is a PUSCH scheduled semi-persistently by the uplink grant.

In one embodiment, a PUSCH occupied by the uplink transmission comprises at least one MAC (Medium Access Control) SDU (Service Data Unit), and a logical channel to which the at least one MAC SDU belongs is configured to allow the use of the uplink grant configured by the first signaling.

In one embodiment, frequency-domain resources indicated by an uplink grant configured by the first signaling belong to a shared spectrum.

In one embodiment, the uplink transmission is an operation with shared spectrum channel access.

In one embodiment, shared spectrum is non-operator spectrum.

In one embodiment, shared spectrum is used for WiFi (Wireless Fidelity).

In one embodiment, LBT (Listen-Before-Talk) process is performed prior to shared spectrum channel access.

In one embodiment, whether the uplink transmission occupies a PUSCH corresponding to the second uplink grant depends on whether a PUSCH corresponding to a first uplink grant is transmitted.

In one embodiment, the meaning of whether the uplink transmission occupies a PUSCH corresponding to the second uplink grant is: whether a PUSCH occupied by the uplink transmission comprises a PUSCH corresponding to the second uplink grant.

In one embodiment, whether a PUSCH corresponding to the first uplink grant is transmitted is used to determine whether the uplink transmission occupies a PUSCH corresponding to the second uplink grant.

In one embodiment, when a PUSCH corresponding to the first uplink grant is transmitted, the uplink transmission occupies a PUSCH corresponding to the second uplink grant.

In one embodiment, when a PUSCH corresponding to the first uplink grant is transmitted, the uplink transmission does not occupy a PUSCH corresponding to the second uplink grant.

In one embodiment, a PUSCH corresponding to an uplink grant occupies a time-frequency resource block indicated by the uplink grant.

In one embodiment, when a PUSCH corresponding to the first uplink grant is not transmitted, the uplink transmission does not occupy a PUSCH corresponding to the second uplink grant.

In one embodiment, the uplink transmission not occupying a PUSCH corresponding to the second uplink grant comprises: the second uplink grant is cancelled.

In one embodiment, the uplink transmission not occupying a PUSCH corresponding to the second uplink grant comprises: the second uplink grant is de-prioritized.

In one embodiment, the uplink transmission not occupying a PUSCH corresponding to the second uplink grant comprises: a PUSCH corresponding to the second uplink grant is not transmitted.

In one embodiment, the uplink transmission not occupying a PUSCH corresponding to the second uplink grant comprises: a candidate for a PUSCH occupied by the uplink transmission does not comprise a PUSCH corresponding to the second uplink grant.

In one embodiment, the uplink transmission not occupying a PUSCH corresponding to the second uplink grant comprises: receiving on at least partial radio resources indicated by the second uplink grant.

In one embodiment, the uplink transmission not occupying a PUSCH corresponding to the second uplink grant comprises: detecting a downlink signal on at least partial radio resources indicated by the second uplink grant.

### Embodiment 2

Embodiment 2 illustrates a schematic diagram of a network architecture according to one embodiment of the present application, as shown in FIG. 2. FIG. 2 is a diagram illustrating a network architecture 200 of 5G NR, Long-Term Evolution (LTE), and Long-Term Evolution Advanced (LTE-A) systems. The NR 5G, LTE or LTE-A network architecture 200 may be called a 5G System (5GS)/Evolved Packet System (EPS) 200 or other appropriate terms. The 5GS/EPS 200 may comprise one or more UEs 201, an NG-RAN 202, a 5G-Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms, and in Non Terrestrial Networks (NTNs), the gNB 203 can be a satellite, an aircraft or a terrestrial base station relayed through a satellite. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), aircrafts, narrow-band physical network devices, machine-type communication devices, land vehicles, automobiles, vehicle equipment, On-board communication unit, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy; a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the NR node B203 corresponds to a second node in the present application.

In one embodiment, the gNB 203 is a Marco Cell base station.

In one embodiment, the gNB 203 is a Micro Cell base station.

In one embodiment, the gNB 203 is a Pico Cell base station.

In one embodiment, the gNB 203 is a Femtocell.

In one embodiment, the gNB 203 is a base station that supports large delay differences.

In one embodiment, the gNB 203 is a flight platform.

In one embodiment, the gNB 203 is satellite equipment.

In one embodiment, the gNB 203 is a test device (e.g., a transceiver device simulating some functions of a base station, a signaling tester).

In one embodiment, the gNB 204 is a Marco Cell base station.

In one embodiment, the gNB 204 is a Micro Cell base station.

In one embodiment, the gNB 204 is a Pico Cell base station.

In one embodiment, the gNB 204 is a Femtocell.

In one embodiment, the gNB 204 is a base station that supports large delay differences.

In one embodiment, the gNB 204 is a flight platform.

In one embodiment, the gNB 204 is satellite equipment.

In one embodiment, the gNB 204 is a test device (e.g., a transceiver device simulating some functions of a base station, a signaling tester).

In one embodiment, a radio link from the UE 201 to the gNB 203/the gNB 204 is an uplink, and the uplink is used for performing an uplink transmission.

In one embodiment, a radio link from the gNB 203/the gNB 204 to the UE 201 is a downlink, and the downlink is used for performing a downlink transmission.

In one embodiment, the UE 201 and the gNB 203/the gNB 204 are respectively connected via a Uu interface.

### Embodiment 3

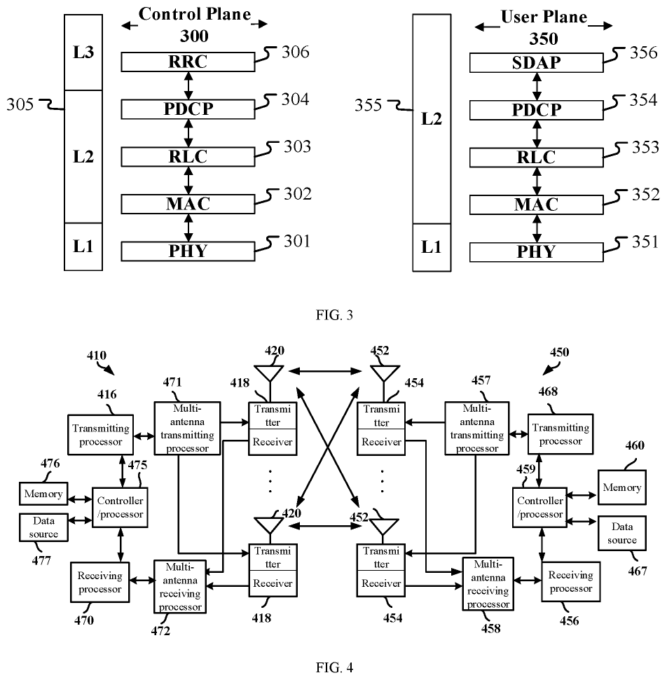

Embodiment 3 illustrates a schematic diagram of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for the control plane 300 of a UE and a gNB is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of the link between the UE and the gNB via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the gNBs of the network side. The PDCP sublayer 304 provides data encryption and integrity protection and also provides support for a UE handover between gNBs. The RLC sublayer 303 provides segmentation and reassembling of a packet, retransmission of a lost data packet through ARQ, as well as repeat data packet detection and protocol error detection. The MAC sublayer 302 provides mapping between a logic channel and a transport channel and multiplexing of the logical channel ID. The MAC sublayer 302 is also responsible for allocating between UEs various radio resources (i.e., resources block) in a cell. The MAC sublayer 302 is also responsible for Hybrid Automatic Repeat Request (HARQ) operation. The Radio Resource Control (RRC) sublayer 306 in layer 3 (L3) of the control plane 300 is responsible for acquiring radio resources (i.e., radio bearer) and configuring the lower layer with an RRC signaling between the gNB and the UE. Although not shown, the RRC sublayer 306 in the control plane 300 of the UE may also have a V2X layer, and the V2X layer is responsible for generating a PC5 QoS parameter group and QoS rules according to received service data or service requests, a PC5 QOS flow is generated corresponding to a PC5 QoS parameter group, and a PC5 QoS flow ID and the corresponding PC5 QOS parameter group are transmitted to an Access Stratum (AS) Layer for QoS processing of a packet belonging to the PC5 QoS flow ID by the AS layer; the V2X layer also comprises a PC5-Signaling Protocol sublayer, and the V2X layer is responsible for indicating whether each transmission of the AS layer is a PC5-S transmission or a V2X service data transmission. The radio protocol architecture of the user plane 350 comprises layer 1 (L1) and layer 2 (L2). In the user plane 350, the radio protocol architecture is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. The radio protocol architecture of the UE in the user plane 350 may comprises part or all of protocol sublayers of the SDAP sublayer 356, the PDCP sublayer 354, the RLC sublayer 353 and the MAC sublayer 352 at L2 layer. Although not described in FIG. 3, the UE may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the PDCP 304 transmits data to or receives data from the RLC303 through an RLC channel.

In one embodiment, the PDCP 354 transmits data to or receives data from the RLC 353 through an RLC channel.

In one embodiment, the RLC 303 transmits data to or receives data from the MAC 302 through a logical channel.

In one embodiment, the RLC 353 transmits data to or receives data from the MAC 352 through a logical channel.

In one embodiment, the MAC 302 transmits data to or receives data from the PHY 301 through a

transmission channel.

In one embodiment, the MAC 352 transmits data to or receives data from the PHY 351 through a

transmission channel.

In one embodiment, the radio protocol architecture in FIG. 3 is applicable to the first node in the

present application.

In one embodiment, the radio protocol architecture in FIG. 3 is applicable to the second node in the

present application. In one embodiment, the first signaling in the present application is generated by the RRC 306.

In one embodiment, the first signaling in the present application is generated by the RRC 306 and the PHY 301 or the PHY 351.

In one embodiment, the first signaling in the present application is generated by the PHY 301 or the PHY 351.

In one embodiment, the first indication in the present application is generated by the PHY 301 or the PHY 351.

In one embodiment, the uplink grant in the present application is generated by the MAC 302 or the MAC 352.

In one embodiment, the first uplink grant in the present application is generated by the MAC 302 or the MAC 352.

In one embodiment, the second uplink grant in the present application is generated by the MAC 302 or the MAC 352.

In one embodiment, the third uplink grant in the present application is generated by the MAC 302 or the MAC 352.

In one embodiment, the L2 layer 305 or 355 belongs to a higher layer.

In one embodiment, the L3 layer RRC sublayer 306 belongs to a higher layer.

### Embodiment 4

Embodiment 4 illustrates a schematic diagram of hardware modules of a communication device

according to one embodiment of the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a data source 477, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from the core network or a higher layer packet from the data source 477 is provided to the controller/processor 475. The core network and the data source 477 represents all protocol layers above the L2 layer. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410 side, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In a transmission from the second communication device 410 to the first communication device 450, the controller/processor 459 provides multiplexing between a transport channel and a logical channel, packet reassembling. decryption, header decompression, control signal processing so as to recover a higher-layer packet from the second communication device 410. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling. decryption, header decompression, control signal processing so as to recover a higher-layer packet from the first communication device 450. The higher layer packet from the controller/processor 475 can be provided to all protocol layers above the core network or the L2 layer, and various control signals can also be provided to the core network or L3 layer for L3 layer processing.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: receives a first signaling, the first signaling is used to configure an uplink grant, the uplink grant configured by the first signaling comprises a first uplink grant and a second uplink grant, the first uplink grant is available for a UCI, the UCI corresponding to the first uplink grant is used to determine whether at least the second uplink grant is not performed; performs an uplink transmission according to a configuration of the first signaling; herein, whether the uplink transmission occupies a PUSCH corresponding to the second uplink grant depends on whether a PUSCH corresponding to the first uplink grant is transmitted.

In one embodiment, the first communication device 450 comprises: a memory that stores a computer readable instruction program. The computer readable instruction program generates an action when executed by at least one processor. The action includes: receiving a first signaling, the first signaling being used to configure an uplink grant, the uplink grant configured by the first signaling comprising a first uplink grant and a second uplink grant, the first uplink grant being available for a UCI, the UCI corresponding to the first uplink grant being used to determine whether at least the second uplink grant is not performed; performing uplink transmission according to the configuration of the first signaling; herein, whether the uplink transmission occupies a PUSCH corresponding to the second uplink grant depends on whether a PUSCH corresponding to the first uplink grant is transmitted.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: transmits a first signaling, the first signaling is used to configure an uplink grant, the uplink grant configured by the first signaling comprises a first uplink grant and a second uplink grant, the first uplink grant is available for a UCI, the UCI corresponding to the first uplink grant is used to determine whether at least the second uplink grant is not performed; performs an uplink reception according to a configuration of the first signaling; herein, whether the uplink reception comprises a PUSCH corresponding to the second uplink grant depends on whether a PUSCH corresponding to the first uplink grant is received.

In one embodiment, the second communication device 410 comprises a memory that stores a computer readable instruction program. The computer readable instruction program generates an action when executed by at least one processor. The action includes: transmitting a first signaling, the first signaling being used to configure an uplink grant, the uplink grant configured by the first signaling comprising a first uplink grant and a second uplink grant, the first uplink grant being available for a UCI, the UCI corresponding to the first uplink grant being used to determine whether at least the second uplink grant is not performed; performing an uplink reception according to a configuration of the first signaling; herein, whether the uplink reception comprises a PUSCH corresponding to the second uplink grant depends on whether a PUSCH corresponding to the first uplink grant is received.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a relay.

In one embodiment, the second communication device 410 is a base station.

In one embodiment, the second communication device 410 is a distribution unit of a base station.

In one embodiment, at least one of the antenna 420, the transmitter 418, the multi-antenna transmitting processor 471, the transmitting processor 416 or the controller/processor 475 is used to transmit a first signaling in the present application.

In one embodiment, at least one of the antenna 452, the receiver 454, the multi-antenna receiving processor 458, the receiving processor 456 or the controller/processor 459 is used to receive a first signaling in the present application.

In one embodiment, at least one of the antenna 420, the transmitter 418, the multi-antenna transmitting processor 471, the transmitting processor 416 or the controller/processor 475 is used to transmit a second signaling in the present application.

In one embodiment, at least one of the antenna 452, the receiver 454, the multi-antenna receiving processor 458, the receiving processor 456 or the controller/processor 459 is used to receive a second signaling in the present application.

In one embodiment, at least one of the antenna 452, the transmitter 454, the multi-antenna transmitting processor 457, the transmitting processor 468 or the controller/processor 459 is used to perform an uplink transmission in the present application.

In one embodiment, at least one of the antenna 420, the receiver 418, the multi-antenna receiving processor 472, the receiving processor 470 or the controller/processor 475 is used to perform an uplink reception in the present application.

In one embodiment, at least one of the antenna 452, the receiver 454, the multi-antenna receiving processor 458, the receiving processor 456 or the controller/processor 459 is used to receive a first indication in the present application.

### Embodiment 5

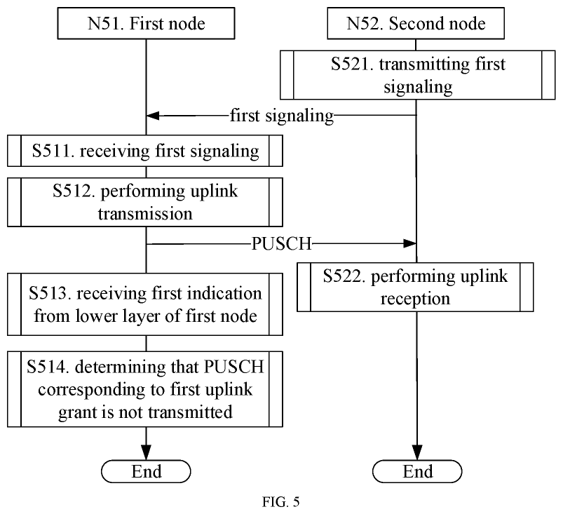

Embodiment 5 illustrates a flowchart of radio signal transmission according to one embodiment in the present application, as shown in FIG. 5. In FIG. 5, a first node N51 and a second node N52 are in communications via a radio interface. It is particularly underlined that the order illustrated in the embodiment does not put constraints over sequences of signal transmissions and implementations.

The first node N51 receives a first signaling in step S511; performs an uplink transmission in step S512; receives a first indication from a lower layer of a first node in step S513; determines that a PUSCH corresponding to a first uplink grant is not transmitted in step S514.

The second node N52 transmits a first signaling in step S521; performs an uplink reception in step S522.

It is noted that step S522 corresponds to step S512, and step S512 may comprise at least one uplink transmission and step S522 may comprise at least one uplink reception; herein, an uplink transmission is a PUSCH transmission.

In embodiment 5, a first signaling is received, the first signaling is used to configure an uplink grant, the uplink grant configured by the first signaling comprises a first uplink grant and a second uplink grant, the first uplink grant is available for a UCI, the UCI corresponding to the first uplink grant is used to determine whether at least the second uplink grant is not performed; an uplink transmission is performed according to a configuration of the first signaling; herein, whether the uplink transmission occupies a PUSCH corresponding to the second uplink grant depends on whether a PUSCH corresponding to the first uplink grant is transmitted; a PUSCH corresponding to the first uplink grant is not transmitted, and a PUSCH corresponding to the second uplink grant is available for the uplink transmission; a PUSCH corresponding to the first uplink grant is transmitted, and whether the uplink transmission occupies a PUSCH corresponding to the second uplink grant is at least dependent on the UCI corresponding to the first uplink grant; a first indication is received from a lower layer of the first node, the first indication is used to determine that a PUSCH corresponding to the first uplink grant is not transmitted.

In one embodiment, the second node N52 is a maintenance base station of a serving cell of the first node N51.

In one embodiment, the second node N52 is a Transmit/Receive Point (TRP) of a serving cell of the first node N51.

In one embodiment, the second node N52 is a maintenance base station of a master cell group (MCG) of the first node N51.

In one embodiment, the second node N52 is a maintenance base station of a Secondary cell group (SCG) of the first node N51.

In one embodiment, the second node N52 is MgNB (master gNB).

In one embodiment, the second node N52 is SgNB (secondary gNB).

In one embodiment, a first indication is received from a lower layer of the first node.

In one embodiment, a MAC entity of the first node receives the first indication from a lower layer of the first node.

In one embodiment, the first indication is received before a PUSCH corresponding to the first uplink grant.

In one embodiment, before a PUSCH corresponding to the first uplink grant comprises: before a PUSCH transmission occasion corresponding to the first uplink grant.

In one embodiment, before a PUSCH corresponding to the first uplink grant comprises: before time-domain resources indicated by the first uplink grant.

In one embodiment, when a lower layer of the first node performs an LBT process prior to a transmission and does not perform a transmission, the lower layer of the first node transmits the first indication to a MAC entity of the first node.

In one embodiment, the lower layer is a protocol layer below the MAC sublayer.

In one embodiment, the lower layer is the physical layer.

In one embodiment, the first indication is a failure to execute a transmission indication.

In one embodiment, the first indication is a failure indication.

In one embodiment, the first indication is a LBT failure indication.

In one embodiment, the first indication is a beam failure indication.

In one embodiment, the first indication is used to determine that a PUSCH corresponding to the first uplink grant is not transmitted.

In one embodiment, the first receiver, when the first indication is received before a PUSCH corresponding to the first uplink grant, determines that a PUSCH corresponding to the first uplink grant is not transmitted.

In one embodiment, the first receiver, when the first indication is not received before a PUSCH corresponding to the first uplink grant, determines that a PUSCH corresponding to the first uplink grant is transmitted.

In one embodiment, the first transmitter transmits a PUSCH corresponding to the first uplink grant.

In one embodiment, before a PUSCH corresponding to each uplink grant configured by the first signaling, if the first indication is not received from a lower layer of the first node, then a PUSCH corresponding to the uplink grant is transmitted; if the first indication is received from a lower layer of the first node, a PUSCH corresponding to the uplink grant is not transmitted.

In one embodiment, a PUSCH corresponding to the first uplink grant is not transmitted, and a PUSCH corresponding to the second uplink grant is available for the uplink transmission.

In one embodiment, a PUSCH corresponding to the second uplink grant being available for the uplink transmission comprises: the uplink transmission occupies a PUSCH corresponding to the second uplink grant.

In one embodiment, a PUSCH corresponding to the second uplink grant being available for the uplink transmission comprises: a candidate for a PUSCH occupied by the uplink transmission comprises a PUSCH corresponding to the second uplink grant.

In one embodiment, a PUSCH corresponding to the second uplink grant being available for the uplink transmission comprises: a PUSCH occupied by the uplink transmission comprises a PUSCH corresponding to the second uplink grant.

In one embodiment, a PUSCH corresponding to the second uplink grant being available for the uplink transmission comprises: a PUSCH corresponding to the second uplink grant is reserved for the uplink transmission.

In one embodiment, a PUSCH corresponding to the second uplink grant being available for the uplink transmission comprises: time-frequency resources indicated by the second uplink grant are reserved for the uplink transmission.

In one embodiment, when a PUSCH corresponding to the first uplink grant is not transmitted, whether a PUSCH corresponding to the second uplink grant is used for the uplink transmission depends on a result of scheduling.

In one embodiment, when a PUSCH corresponding to the first uplink grant is not transmitted, whether a PUSCH corresponding to the second uplink grant is used for the uplink transmission is determined by the UE itself.

In one embodiment, a PUSCH corresponding to the second uplink grant comprises at least one MAC SDU, and a logical channel to which the at least one MAC SDU belongs not being configured allows the use of the uplink grant configured with the first signaling; herein, a PUSCH corresponding to the first uplink grant is not transmitted.

In one embodiment, a PUSCH corresponding to the second uplink grant comprises at least one MAC SDU, a logical channel to which one of the at least one MAC SDU belongs not being configured allows the use of the uplink grant configured with the first signaling; herein, a PUSCH corresponding to the first uplink grant is not transmitted.

In one embodiment, when a PUSCH corresponding to the first uplink grant is transmitted, and whether the uplink transmission occupies a PUSCH corresponding to the second uplink grant is at least dependent on the UCI corresponding to the first uplink grant.

In one subembodiment of the above embodiment, time-domain resources of the PUSCH corresponding to the second uplink grant are not used for dynamically-scheduled PUSCH transmissions, and the first node is not configured to skip a PUSCH transmission corresponding to a configured grant.

In one subembodiment of the above embodiment, when the UCI corresponding to the first uplink grant indicates a PUSCH transmission occasion corresponding to the second uplink grant, the uplink transmission does not occupy a PUSCH corresponding to the second uplink grant.

In one subembodiment of the above embodiment, when the UCI corresponding to the first uplink grant indicates that the second uplink grant is not performed, the uplink transmission does not occupy a PUSCH corresponding to the second uplink grant.

In one subembodiment of the above embodiment, when the UCI corresponding to the first uplink grant indicates that the second uplink grant is performed, the uplink transmission occupies a PUSCH corresponding to the second uplink grant.

In one subembodiment of the above embodiment, when the UCI corresponding to the first uplink grant indicates that the second uplink grant is performed, whether the uplink transmission occupies a PUSCH corresponding to the second uplink grant depends on a result of scheduling.

### Embodiment 6

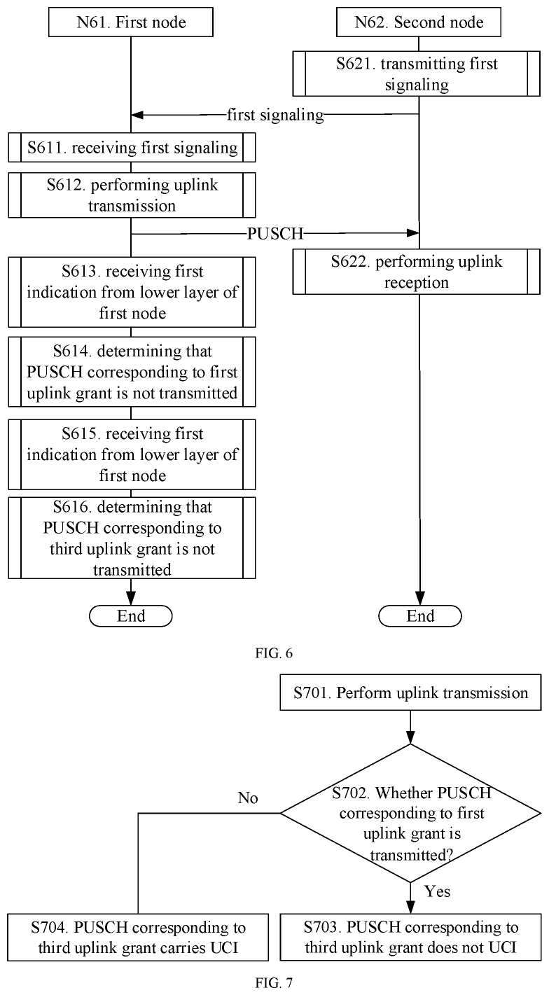

Embodiment 6 illustrates a flowchart of radio signal transmission according to one embodiment of the present application, as shown in FIG. 6. In FIG. 6, The first node N61 and the second node N62 are in communications via a radio interface. It is particularly underlined that the order illustrated in the embodiment does not put constraints over sequences of signal transmissions and implementations.

The first node N61 receives a first signaling in step S611; performs an uplink transmission in step S612; receives a first indication from a lower layer of a first node in step S613; determines that a PUSCH corresponding to a first uplink grant is not transmitted in step S614; receives a first indication from a lower layer of a first node in step S615; determines that a PUSCH corresponding to a third uplink grant is not transmitted in step S616.

The second node N62 transmits a first signaling in step S621; performs an uplink reception in step S622.

It is noted that step S622 corresponds to step S612, and step S612 may comprise at least one uplink transmission and step S622 may comprise at least one uplink reception; herein, an uplink transmission is a PUSCH transmission.

In embodiment 6, a first signaling is received, the first signaling is used to configure an uplink grant, the uplink grant configured by the first signaling comprises a first uplink grant and a second uplink grant, the first uplink grant is available for a UCI, the UCI corresponding to the first uplink grant is used to determine whether at least the second uplink grant is not performed; an uplink transmission according to a configuration of the first signaling is performed; herein, whether the uplink transmission occupies a PUSCH corresponding to the second uplink grant depends on whether a PUSCH corresponding to the first uplink grant is transmitted; whether the uplink transmission occupies a PUSCH corresponding to the second uplink grant depends on whether a PUSCH corresponding to a third uplink grant is transmitted, the third uplink grant is available for a UCI, and a UCI corresponding to the third uplink grant is used to determine whether at least the second uplink grant is not performed; the first uplink grant, the third uplink grant and the second uplink grant are configured by a same configured grant configuration, and the first signaling comprises the same configured grant configuration.

The first node N61 and the second node N62 in Embodiment 6 are the same as the first node N51 and the second node N52 in Embodiment 5 and will not be repeated herein.

Steps S611, S612, S613 and S614 in Embodiment 6 are the same as corresponding steps in Embodiment 5; steps S621 and S622 in Embodiment 6 are the same as corresponding steps in Embodiment 5 and will not be repeated here.

In one embodiment, whether the uplink transmission occupies a PUSCH corresponding to the second uplink grant depends on whether a PUSCH corresponding to a third uplink grant is transmitted.

In one subembodiment of the above embodiment, a PUSCH corresponding to the first uplink grant is not transmitted.

In one subembodiment of the above embodiment, a PUSCH corresponding to the first uplink grant is transmitted.

In one embodiment, the third uplink grant is available for a UCI, and a UCI corresponding to the third uplink grant is used to determine whether at least the second uplink grant is not performed.

In one embodiment, whether a PUSCH corresponding to the third uplink grant is transmitted is used to determine whether the uplink transmission occupies a PUSCH corresponding to the second uplink grant.

In one embodiment, whether at least one of a PUSCH corresponding to the first uplink grant or a PUSCH corresponding to the third uplink grant is transmitted is used to determine whether the uplink transmission occupies a PUSCH corresponding to the second uplink grant.

In one embodiment, when a PUSCH corresponding to the first uplink grant is not transmitted, a PUSCH corresponding to the third uplink grant carries a UCI.

In one embodiment, when a PUSCH corresponding to the first uplink grant is not transmitted, whether a PUSCH corresponding to the second uplink grant is transmitted depends on whether a PUSCH corresponding to the third uplink grant is transmitted.

In one embodiment, when a PUSCH corresponding to the first uplink grant is not transmitted, whether a PUSCH corresponding to the third uplink grant is transmitted is used to determine whether the uplink transmission occupies a PUSCH corresponding to the second uplink grant.

In one embodiment, a PUSCH corresponding to the first uplink grant is not transmitted and a PUSCH corresponding to the third uplink grant is transmitted, whether the uplink transmission occupies a PUSCH corresponding to the second uplink grant is at least dependent on the UCI corresponding to the third uplink grant.

In one subembodiment of the above embodiment, when the UCI corresponding to the third uplink grant indicates a PUSCH transmission occasion corresponding to the second uplink grant, the uplink transmission does not occupy a PUSCH corresponding to the second uplink grant.

In one subembodiment of the above embodiment, when the UCI corresponding to the third uplink grant indicates that the second uplink grant is not performed, the uplink transmission does not occupy a PUSCH corresponding to the second uplink grant.

In one subembodiment of the above embodiment, when the UCI corresponding to the third uplink grant indicates that the second uplink grant is performed, the uplink transmission occupies a PUSCH corresponding to the second uplink grant.

In one subembodiment of the above embodiment, when the UCI corresponding to the third uplink grant indicates that the second uplink grant is performed, whether the uplink transmission occupies a PUSCH corresponding to the second uplink grant depends on a result of scheduling.

In one embodiment, when a PUSCH corresponding to the first uplink grant is not transmitted and a PUSCH corresponding to the third uplink grant is transmitted, the uplink transmission does not occupy a PUSCH corresponding to the second uplink grant.

In one embodiment, when a PUSCH corresponding to the first uplink grant is not transmitted and a PUSCH corresponding to the third uplink grant is transmitted, the uplink transmission occupies a PUSCH corresponding to the second uplink grant.

In one embodiment, when a PUSCH corresponding to the first uplink grant is not transmitted and a PUSCH corresponding to the third uplink grant is not transmitted, the uplink transmission does not occupy a PUSCH corresponding to the second uplink grant.

In one embodiment, when a PUSCH corresponding to the first uplink grant is not transmitted and a PUSCH corresponding to the third uplink grant is not transmitted, the uplink transmission occupies a PUSCH corresponding to the second uplink grant.

In one embodiment, when a PUSCH corresponding to the first uplink grant is not transmitted and a PUSCH corresponding to the third uplink grant is not transmitted, a PUSCH corresponding to the second uplink grant is available for the uplink transmission.

In one embodiment, when a PUSCH corresponding to the first uplink grant is not transmitted and a PUSCH corresponding to the third uplink grant is not transmitted, whether a PUSCH corresponding to the second uplink grant is used for the uplink transmission depends on a result of the scheduling.

In one embodiment, when a PUSCH corresponding to the first uplink grant is not transmitted and a PUSCH corresponding to the third uplink grant is not transmitted, whether a PUSCH corresponding to the second uplink grant is used for the uplink transmission is determined by the UE itself.

In one embodiment, the first uplink grant, the third uplink grant and the second uplink grant are configured by a same configured grant configuration.

In one embodiment, the first signaling comprises the same configured grant configuration.

In one embodiment, the first uplink grant, the third uplink grant and the second uplink grant belong to the uplink grant configured by the first signaling.

In one embodiment, the first uplink grant, the third uplink grant and the second uplink grant are sequentially ordered in time domain.

### Embodiment 7

Embodiment 7 illustrates a flowchart of the processing of a signal in a first node according to one embodiment of the present application, as shown in FIG. 7.

In Embodiment 7, a first node performs an uplink transmission in step S701; judges in step S702 whether a PUSCH corresponding to a first uplink grant is transmitted, and if yes, performs step S703, and if no, performs step S704; determines in step S703 that a PUSCH corresponding to a third uplink grant does not carry a UCI; determines in step S704 that a PUSCH corresponding to a third uplink grant carries a UCI.

In one embodiment, when the PUSCH corresponding to the first uplink grant is not transmitted, a PUSCH corresponding to the third uplink grant carries a UCI.

In one embodiment, when the PUSCH corresponding to the first uplink grant is transmitted, a PUSCH corresponding to the third uplink grant does not carry a UCI; herein, a PUSCH corresponding to the first uplink grant carries a UCI.

In one embodiment, the above method can save the signaling overhead.

In one embodiment, when the PUSCH corresponding to the first uplink grant is transmitted, a PUSCH corresponding to the third uplink grant carries a UCI; herein, a PUSCH corresponding to the first uplink grant carries a UCI.

In one embodiment, the above method improves the transmission robustness of UCI.

### Embodiment 8

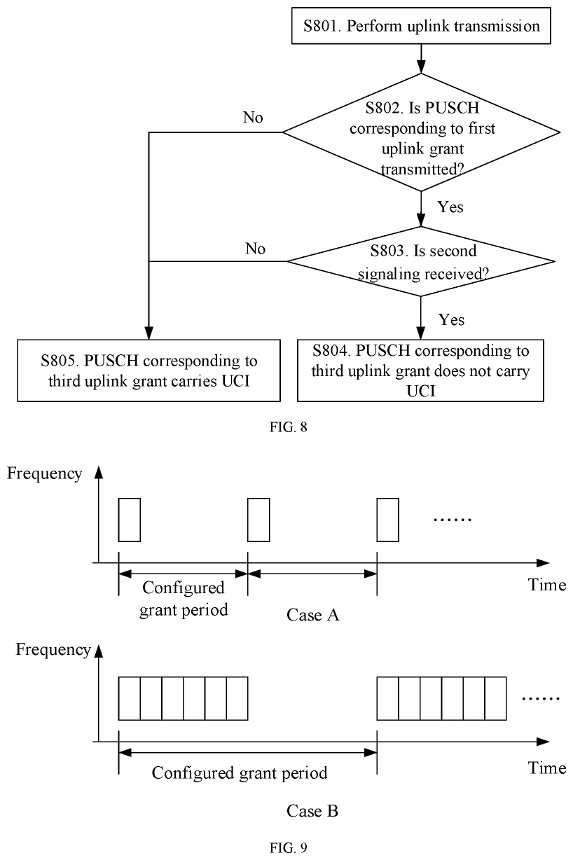

Embodiment 8 illustrates a flowchart of the processing of a signal in a first node according to one embodiment of the present application, as shown in FIG. 8.

In Embodiment 8, a first node performs an uplink transmission in step S801; judges in step S802 whether a PUSCH corresponding to a first uplink grant is transmitted, if yes, performs step S803, if no, performs step S805; in step S803, judges whether a second signaling is received, if yes, performs step S804, if no, performs step S805; determines in step S804 that a PUSCH corresponding to a third uplink grant does not carry a UCI; determines in step S805 that a PUSCH corresponding to a third uplink grant carries a UCI.

In one embodiment, when the PUSCH corresponding to the first uplink grant is transmitted, whether a PUSCH corresponding to the third uplink grant carries a UCI depends on whether the second signaling is received; herein, a PUSCH corresponding to the first grant carries a UCI.

In one subembodiment of the above embodiment, when the second signaling is received, a PUSCH corresponding to the third uplink grant does not carry a UCI.

In one subembodiment of the above embodiment, when the second signaling is not received, a PUSCH corresponding to the third uplink grant carries a UCI.

In one embodiment, the above method improves the transmission robustness of UCI while saving the signaling overhead.

In one embodiment, the second signaling is received from a target receiver of the uplink transmission.

In one embodiment, the second signaling is received from a second node in the present application.

In one embodiment, the second signaling is received before the a PUSCH transmission occasion corresponding to the third uplink grant.

In one embodiment, the second signaling indicates that the PUSCH corresponding to the first uplink grant is successfully received.

In one embodiment, the second signaling is a PDCCH.

In one embodiment, a HARQ (Hybrid Automatic Repeat Request) process ID indicated by the second signaling is the same as a HARQ process ID to which a PUSCH corresponding to the first uplink grant belongs; a NDI (New Data Indication) comprised in the second signaling is toggled.

In one embodiment, a CRC of the second signaling is scrambled by a C-RNTI (Cell Radio Network Temporary Identity).

In one embodiment, the C-RNTI uniquely identifies the first node within a serving cell of the first node.

### Embodiment 9

Embodiment 9 illustrates a schematic diagram of an uplink grant configured by a first signaling according to one embodiment of the present application, as shown in FIG. 9. The rectangle in FIG. 9 represents a PUSCH corresponding to an uplink grant, or, a time-frequency resource block indicated by an uplink grant. In one embodiment, an uplink grant configured by the first signaling comprises multiple uplink grants.

In one embodiment, an uplink grant configured by the first signaling does not occur periodically.

In one embodiment, an uplink grant configured by the first signaling occurs periodically.

In one embodiment, a time-frequency resource block is comprised in a configured grant cycle.

In one embodiment, multiple time-frequency resource blocks are comprised in a configured grant cycle, and the multiple time-frequency resource blocks comprised in the configured grant cycle correspond to multiple uplink grants.

In one embodiment, multiple time-frequency resource blocks comprised in a configured grant cycle are continuous in time domain.

In one embodiment, multiple time-frequency resource blocks comprised in a configured grant cycle are discontinuous in time domain.

In one embodiment, a time-frequency resource block comprises at least one time-domain resource and at least one frequency-domain resource.

In one embodiment, one time-domain resource comprises at least one Orthogonal Frequency Division Multiplexing (OFDM) symbol.

In one embodiment, one time-domain resource comprises at least one slot.

In one embodiment, one frequency-domain resource comprises at least one subcarrier.

In one embodiment, one frequency-domain resource comprises at least one resource block (RB).

In one embodiment, a configured grant cycle consists of at least one millisecond (ms).

In one embodiment, a configured grant cycle comprises a duration of at least one symbol, and the duration of at least one symbol is related to a subcarrier spacing.

In case A of embodiment 9, an uplink grant configured by the first signaling occurs periodically, and one uplink grant is comprised in each configured grant cycle.

In case B of embodiment 9, an uplink grant configured by the first signaling occurs periodically, six uplink grants are comprised in each configured grant cycle, and the six uplink grants are continuous in time domain.

### Embodiment 10

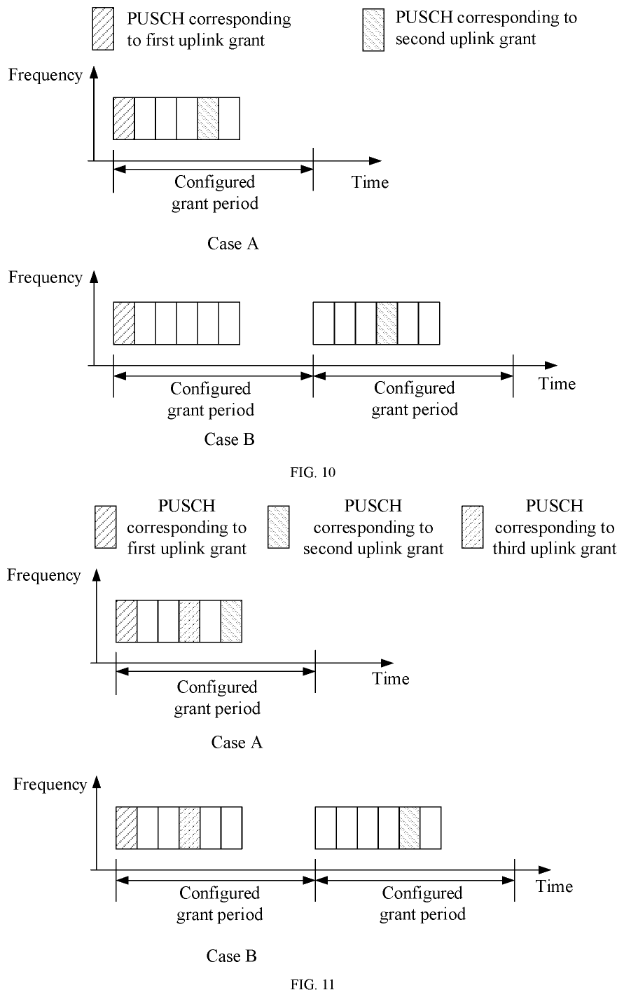

Embodiment 10 illustrates a schematic diagram of a first uplink grant and a second uplink grant according to one embodiment of the present application, as shown in FIG. 10. In FIG. 10, the rectangle represents a PUSCH corresponding to an uplink grant, or, a time-frequency resource block indicated by an uplink grant; the forward slash rectangle represents a PUSCH corresponding to a first uplink grant, or, a time-frequency resource block indicated by a first uplink grant; the backslash rectangle represents a PUSCH corresponding to the second uplink grant, or, a time-frequency resource block indicated by a second uplink grant.

Embodiment 10 comprises the first uplink grant and does not comprise the third uplink grant.

Embodiment 10 is illustrated by the example of a periodic occurrence of an uplink grant configured by the first signaling, without excluding the scenario where an uplink grant configured by the first signaling does not occur periodically.

In one embodiment, a position of the first uplink grant in an uplink grant configured by the first signaling is configured by the network.

In one embodiment, the first uplink grant occurs periodically; herein, the uplink grant configured by the first signaling is periodic.

In one embodiment, a position of a first uplink grant in an uplink grant configured by the first signaling is pre-defined.

In one embodiment, a position of the first uplink grant in an uplink grant configured by the first signaling is the first one in a configured grant cycle.

In one subembodiment of the above embodiment, a position of the second uplink grant in an uplink grant configured by the first signaling is after the first uplink grant in a configured grant cycle.

In one subembodiment of the above embodiment, the configured grant cycle comprises at least two uplink grants.

In one embodiment, a UCI is used to determine continuous or discontinuous uplink grants that are not performed in the configured grant cycle.

In one embodiment, a UCI is used to determine continuous or discontinuous uplink grants that are not performed in the configured grant cycle after the first uplink grant.

In one embodiment, a position of the first uplink grant in an uplink grant configured by the first signaling is the first one in Q1 configured grant cycles; herein, Q1 is a positive integer greater than 1, and Q1 is network configured.

In one subembodiment of the above embodiment, a position of the second uplink grant in an uplink grant configured by the first signaling is after the first uplink grant in the Q1 configured grant cycles.

In one embodiment, a UCI is used to determine continuous or discontinuous uplink grants that are not performed in the Q1 configured grant cycles.

In one embodiment, a UCI is used to determine continuous or discontinuous uplink grants that are not performed in the Q1 configured grant cycles after the first uplink grant.

In one embodiment, a position of the first uplink grant in an uplink grant configured by the first signaling is a first one in a configured grant cycle in which a corresponding PUSCH is transmitted.

In one subembodiment of the above embodiment, a position of the second uplink grant in an uplink grant configured by the first signaling is after the first uplink grant in a configured grant cycle.

In one subembodiment of the above embodiment, the configured grant cycle comprises at least two uplink grants.

In one embodiment, a position of the first uplink grant in an uplink grant configured by the first signaling is the first one in Q2 configured grant cycles in which a corresponding PUSCH is transmitted; herein, Q2 is a positive integer greater than 1, and Q2 is network configured.

In one subembodiment of the above embodiment, a position of the second uplink grant in an uplink grant configured by the first signaling is after the first uplink grant in the Q2 configured grant cycless.

In one embodiment, a UCI is used to determine continuous or discontinuous uplink grants that are not performed in the Q2 configured grant cycles.

In one embodiment, a UCI is used to determine continuous or discontinuous uplink grants that are not performed after the first uplink grant in the Q2 configured grant cycles.

In case A of Embodiment 10, a configured grant cycle comprises six uplink grants, a position of the first uplink grant is a first one among six uplink grants comprised in a configured grant cycle, and a position of the second uplink grant is a fifth one among six uplink grants comprised in the configured grant cycle.

In case B of Embodiment 10, a configured grant cycle comprises 6 uplink grants, a position of the first uplink grant is a first one of 12 uplink grants comprised in two configured grant cycles, and a position of the second uplink grant is a tenth one among 12 uplink grants comprised in the two configured grant cycles.

In one embodiment, the second uplink grant is a first uplink grant that may be indicated by a UCI corresponding to the first uplink grant.

In one embodiment, the second uplink grant is any one of uplink grants that may be indicated by a UCI corresponding to the first uplink grant.

In one embodiment, the second uplink grant is one of uplink grants that may be indicated by a UCI corresponding to the first uplink grant.

In one embodiment, a PUSCH corresponding to the second uplink grant is after a PUSCH corresponding to the first uplink grant.

In one embodiment, the second uplink grant is an uplink grant immediately following the first uplink grant.

In one embodiment, an interval between the second uplink grant and the first uplink grant is not less than a first threshold, and the first threshold is configured by the network.

In one embodiment, the first uplink grant and the second uplink grant belong to a same configured grant cycle.

In one embodiment, the first uplink grant and the second uplink grant belong to different configured grant cycles.

### Embodiment 11

Embodiment 11 illustrates a schematic diagram of a first uplink grant, a third uplink grant and a second uplink grant according to one embodiment of the present application, as shown in FIG. 11. In FIG. 11, the rectangle represents a PUSCH corresponding to an uplink grant, or, a time-frequency resource block indicated by an uplink grant; the forward slash rectangle represents a PUSCH corresponding to a first uplink grant, or, a time-frequency resource block indicated by a first uplink grant; the cross-line filled rectangle represents a PUSCH corresponding to a third uplink grant, or, a time-frequency resource block indicated by a third uplink grant; the backslash rectangle represents a PUSCH corresponding to a second uplink grant, or, a time-frequency resource block indicated by a second uplink grant.

Embodiment 11 comprises first uplink grant and the third uplink grant.

A position of the first uplink grant in an uplink grant configured by the first signaling in Embodiment 11 is the same as in Embodiment 10, which will not be repeated here.

In one embodiment, a position of the third uplink grant in an uplink grant configured by the first signaling is configured by the network.

In one embodiment, the third uplink grant occurs periodically; herein, the uplink grant configured by the first signaling is periodic.

In one embodiment, a position of a third uplink grant in an uplink grant configured by the first signaling is pre-defined.

In one embodiment, a position of the third uplink grant in an uplink grant configured by the first signaling is a K1-th one in a configured grant cycle; herein, K1 is greater than 1 and less than a number of uplink grant(s) comprised in the configured grant cycle.

In one subembodiment of the above embodiment, a position of the second uplink grant in an uplink grant configured by the first signaling is after the third uplink grant in a configured grant cycle.

In one subembodiment of the above embodiment, the configured grant cycle comprises at least three uplink grants.

In one embodiment, a position of the third uplink grant in an uplink grant configured by the first signaling is a K2-th one in the Q1 configured grant cycles; herein, the K2 is greater than 1 and less than a number of uplink grant(s) comprised in the Q1 configured grant cycles.

In one subembodiment of the above embodiment, a position of the second uplink grant in an uplink grant configured by the first signaling is after the third uplink grant in the Q1 configured grant cycles.

In one embodiment, a UCI is used to determine continuous or discontinuous uplink grants that are not performed after the third uplink grant in the Q1 configured grant cycles.

In one embodiment, the third uplink grant is located after the first uplink grant and is spaced from the first uplink grant by K3 uplink grant(s) configured by the first signaling; herein, K3 is a non-negative integer, and K3 is configured by the network.

In one embodiment, when a PUSCH corresponding to the first uplink grant is not transmitted, the uplink transmission does not occupy a PUSCH corresponding to an uplink grant configured by the first signaling after time-domain resources indicated by the first uplink grant and before time-domain resources indicated by the third uplink grant.

In one embodiment, when a PUSCH corresponding to the first uplink grant is not transmitted, the uplink transmission does not occupy a PUSCH corresponding to an uplink grant configured by the first signaling after a PUSCH corresponding to the first uplink grant and before a PUSCH corresponding to the third uplink grant.

In one embodiment, when a PUSCH corresponding to the first uplink grant is not transmitted, the uplink transmission occupies a PUSCH corresponding to an uplink grant configured by the first signaling after time-domain resources indicated by the first uplink grant and before time-domain resources indicated by the third uplink grant.

In one embodiment, when a PUSCH corresponding to the first uplink grant is not transmitted, the uplink transmission occupies a PUSCH corresponding to an uplink grant configured by the first signaling after a PUSCH corresponding to the first uplink grant and before a PUSCH corresponding to the third uplink grant.

In case A of Embodiment 11, a configured grant cycle comprises six uplink grants, a position of the first uplink grant is a first one among six uplink grants comprised in a configured grant cycle, and a position of the third uplink grant is a fourth one among six uplink grants comprised in a configured grant cycle.

In case B of Embodiment 11, one configured grant cycle comprises 6 uplink grants, a position of the first uplink grant is a first one among 12 uplink grants comprised in two configured grant cycles, and a position of the third uplink grant is a fourth one among 12 uplink grants comprised in the two configured grant cycles.

In one embodiment, the second uplink grant is a first one of uplink grants that may be indicated by a UCI corresponding to the third uplink grant.

In one embodiment, the second uplink grant is any one of the uplink grants that may be indicated by a UCI corresponding to the third uplink grant.

In one embodiment, the second uplink grant is one of the uplink grants that may be indicated by a UCI corresponding to the third uplink grant.

In one embodiment, the second uplink grant is an uplink grant immediately following the third uplink grant.

In one embodiment, an interval between the second uplink grant and the third uplink grant is not less than a first threshold, and the first threshold is configured by the network.

In one embodiment, the third uplink grant and the second uplink grant belong to a same configured grant cycle.

In one embodiment, the third uplink grant and the second uplink grant belong to different configured grant cycles.

### Embodiment 12

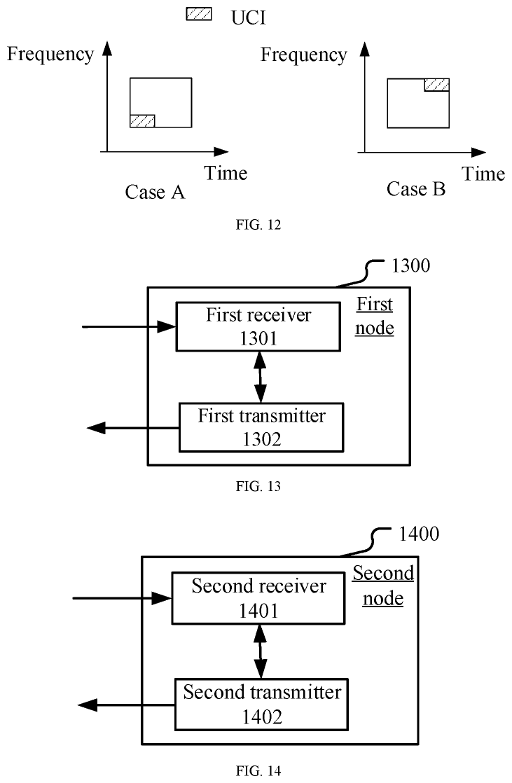

Embodiment 12 illustrates a schematic diagram of a relation between a PUSCH corresponding to a first uplink grant and UCI according to one embodiment of the present application, as shown in FIG. 12. In FIG. 12, the large rectangle represents a PUSCH corresponding to a first uplink grant, or a time-frequency resource block indicated by a first uplink grant; the slash-filled rectangle represents a UCI.

In one embodiment, the first uplink grant is available for a UCI.

In one embodiment, a UCI is multiplexed onto a PUSCH corresponding to the first uplink grant to be transmitted.

In one embodiment, a UCI transmission occupies partial time-frequency resources indicated by the first uplink grant.

In one embodiment, partial time-frequency resources indicated by the first uplink grant occupied by a UCI transmission are configured by the network.

In one embodiment, partial time-frequency resources indicated by the first uplink grant occupied by a UCI transmission are predefined.

In one embodiment, a PUSCH corresponding to the first uplink grant carries a TB (Transport Block) and a UCI.

In one embodiment, a TB and a UCI carried by a PUSCH corresponding to the first uplink grant are respectively coded and decoded.

In one subembodiment of the above embodiment, a TB carried by a PUSCH corresponding to the first uplink grant is successfully decoded; a UCI carried by a PUSCH corresponding to the first uplink grant is decoded successfully.

In one subembodiment of the above embodiment, a TB carried by a PUSCH corresponding to the first uplink grant is decoded not successfully; a UCI carried by a PUSCH corresponding to the first uplink grant is decoded successfully.

In case A of Embodiment 12, a UCI occupies partial time-frequency resources located at a starting position of time-frequency resources indicated by the first uplink grant.

In case B of Embodiment 12, a UCI occupies partial time-frequency resources located at an end position of time-frequency resources indicated by the first uplink grant.

It should be noted that a relation between a PUSCH corresponding to the third uplink grant and a UCI is the same as a relation between a PUSCH corresponding to the first uplink grant and a UCI, which will not be repeated here.

### Embodiment 13

Embodiment 13 illustrates a structure block diagram of a processor in a first node according to one embodiment of the present application, as shown in FIG. 13. In FIG. 13, a processor 1300 of the first node comprises a first receiver 1301 and a first transmitter 1302; the first node 1300 is a UE.

In embodiment 13, the first receiver 1301 receives a first signaling, the first signaling is used to configure an uplink grant, the uplink grant configured by the first signaling comprises a first uplink grant and a second uplink grant, the first uplink grant is available for a UCI, the UCI corresponding to the first uplink grant is used to determine whether at least the second uplink grant is not performed; the first transmitter 1302 performs an uplink transmission according to a configuration of the first signaling; herein, whether the uplink transmission occupies a PUSCH corresponding to the second uplink grant depends on whether a PUSCH corresponding to the first uplink grant is transmitted.

In on embodiment, whether the uplink transmission occupies a PUSCH corresponding to the second uplink grant depends on whether a PUSCH corresponding to a third uplink grant is transmitted, the third uplink grant is available for a UCI, and a UCI corresponding to the third uplink grant is used to determine whether at least the second uplink grant is not performed; the first uplink grant, the third uplink grant and the second uplink grant are configured by a same configured grant configuration, and the first signaling comprises the same configured grant configuration.

In on embodiment, whether the uplink transmission occupies a PUSCH corresponding to the second uplink grant depends on whether a PUSCH corresponding to a third uplink grant is transmitted, the third uplink grant is available for a UCI, and a UCI corresponding to the third uplink grant is used to determine whether at least the second uplink grant is not performed; the first uplink grant, the third uplink grant and the second uplink grant are configured by a same configured grant configuration, and the first signaling comprises the same configured grant configuration; the PUSCH corresponding to the first uplink grant is transmitted, and a PUSCH corresponding to the third uplink grant does not carry a UCI.

In on embodiment, whether the uplink transmission occupies a PUSCH corresponding to the second uplink grant depends on whether a PUSCH corresponding to a third uplink grant is transmitted, the third uplink grant is available for a UCI, and a UCI corresponding to the third uplink grant is used to determine whether at least the second uplink grant is not performed; the first uplink grant, the third uplink grant and the second uplink grant are configured by a same configured grant configuration, and the first signaling comprises the same configured grant configuration; the first receiver 1301 receives a second signaling, and the second signaling indicates that the PUSCH corresponding to the first uplink grant is successfully received; herein, the PUSCH corresponding to the first uplink grant is transmitted; the PUSCH corresponding to the third uplink grant does not carry a UCI.

In one embodiment, a PUSCH corresponding to the first uplink grant is not transmitted, and a PUSCH corresponding to the second uplink grant is available for the uplink transmission.

In one embodiment, a PUSCH corresponding to the first uplink grant is transmitted, and whether the uplink transmission occupies a PUSCH corresponding to the second uplink grant is at least dependent on the UCI corresponding to the first uplink grant.

In one embodiment, the first receiver 1301 receives a first indication from a lower layer of the first node, and the first indication is used to determine that a PUSCH corresponding to the first uplink grant is not transmitted.

In one embodiment, the first receiver 1301 comprises the receiver 454 (comprising the antenna 452), the receiving processor 456, the multi-antenna receiving processor 458 and the controller/processor 459 in FIG. 4 of the present application.

In one embodiment, the first receiver 1301 comprises at least one of the receiver 454 (comprising the antenna 452), the receiving processor 456, the multi-antenna receiving processor 458 or the controller/processor 459 in FIG. 4 of the present application.

In one embodiment, the first transmitter 1302 comprises the transmitter 454 (comprising the antenna 452), the transmitting processor 468, the multi-antenna transmitting processor 457 and the controller/processor 459 in FIG. 4 of the present application.

In one embodiment, the first transmitter 1302 comprises at least one of the transmitter 454 (comprising the antenna 452), the transmitting processor 468, the multi-antenna transmitting processor 457 or the controller/processor 459 in FIG. 4 of the present application.

### Embodiment 14

Embodiment 14 illustrates a structure block diagram of a processor in a second node according to one embodiment of the present application, as shown in FIG. 14. In FIG. 14, a processor 1400 of a second node comprises a second receiver 1401 and a second transmitter 1402; the second node 1400 is a base station.

In embodiment 14, the second transmitter 1402 transmits a first signaling, the first signaling is used to configure an uplink grant, the uplink grant configured by the first signaling comprises a first uplink grant and a second uplink grant, the first uplink grant is available for a UCI, the UCI corresponding to the first uplink grant is used to determine whether at least the second uplink grant is not performed; the second receiver 1401 performs an uplink reception according to a configuration of the first signaling; herein, whether the uplink reception comprises a PUSCH corresponding to the second uplink grant depends on whether a PUSCH corresponding to the first uplink grant is received.

In on embodiment, whether the uplink reception comprises whether a PUSCH corresponding to the second uplink grant is received depends on whether a PUSCH corresponding to the third uplink grant is received, the third uplink grant is available for a UCI, and whether UCI corresponding to the third uplink grant is used to determine whether at least the second uplink grant is not executed; the first uplink grant, the third uplink grant and the second uplink grant are configured by a same configured grant configuration, and the first signaling comprises the same configured grant configuration.

In on embodiment, whether the uplink reception comprises whether a PUSCH corresponding to the second uplink grant is received depends on whether a PUSCH corresponding to the third uplink grant is received, the third uplink grant is available for a UCI, and whether UCI corresponding to the third uplink grant is used to determine whether at least the second uplink grant is not executed; the first uplink grant, the third uplink grant and the second uplink grant are configured by a same configured grant configuration, and the first signaling comprises the same configured grant configuration; the PUSCH corresponding to the first uplink grant is received, and a PUSCH corresponding to the third uplink grant does not carry a UCI.

In on embodiment, whether the uplink reception comprises whether a PUSCH corresponding to the second uplink grant is received depends on whether a PUSCH corresponding to the third uplink grant is received, the third uplink grant is available for a UCI, and whether UCI corresponding to the third uplink grant is used to determine whether at least the second uplink grant is not executed; the first uplink grant, the third uplink grant and the second uplink grant are configured by a same configured grant configuration, and the first signaling comprises the same configured grant configuration; the second transmitter 1402 transmits a second signaling, and the second signaling indicates that the PUSCH corresponding to the first uplink grant is successfully received; herein, the PUSCH corresponding to the first uplink grant is received; the PUSCH corresponding to the third uplink grant does not carry a UCI.

In one embodiment, a PUSCH corresponding to the first uplink grant is not received, and a PUSCH corresponding to the second uplink grant is available for the uplink reception.

In one embodiment, a PUSCH corresponding to the first uplink grant is received, and whether the uplink reception comprises a PUSCH corresponding to the second uplink grant is at least dependent on the UCI corresponding to the first uplink grant.

In one embodiment, a receiver of the first signaling receives a first indication from a lower layer, the first indication being used to determine that a PUSCH corresponding to the first uplink grant is not transmitted.

In one embodiment, the second receiver 1401 comprises the receiver 418 (comprising the antenna 420), the receiving processor 470, the multi-antenna receiving processor 472 and the controller/processor 475 in FIG. 4 in the present application.

In one embodiment, the second receiver 1401 comprises at least one of the receiver 418 (comprising the antenna 420), the receiving processor 470, the multi-antenna receiving processor 472 or the controller/processor 475 in FIG. 4 in the present application.

In one embodiment, the second transmitter 1402 comprises the transmitter 418 (including the antenna 420), the transmitting processor 416, the multi-antenna transmitting processor 471 and controller/processor 475 in FIG. 4 of the present application.

In one embodiment, the second transmitter 1402 comprises at least one of the transmitter 418 (including the antenna 420), the transmitting processor 416, the multi-antenna transmitting processor 471 or the controller/processor 475 in FIG. 4 of the present application.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. A first-type communication node or a UE or a terminal in the present application includes but not limited to mobile phones, tablet computers, laptops, network cards, low-power devices, enhanced Machine Type Communication (eMTC) devices, NB-IOT devices, vehicle-mounted communication equipment, aircrafts, airplanes, unmanned aerial vehicles (UAV), tele-controlled aircrafts and other wireless communication devices. The second-type communication node or the base station or the network side device in the present application includes but is not limited to the macro-cellular base stations, micro-cellular base stations, home base stations, relay base stations, eNB, gNB, Transmission and Reception Points (TRP), relay satellites, satellite base stations, air base stations and other wireless communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first signaling, the first signaling configuring uplink grant, the uplink grant configured by the first signaling comprising a first uplink grant and a second uplink grant, the first uplink grant being available for a UCI (Uplink control information), the UCI corresponding to the first uplink grant being used to determine at least whether the second uplink grant is not performed, and the not performed referring to a PUSCH (Physical uplink shared channel) corresponding to an uplink grant is not transmitted; and
a first transmitter, performing uplink transmission according to the configuration of the first signaling;
wherein whether the uplink transmission occupies a PUSCH corresponding to the second uplink grant depends on whether a PUSCH corresponding to the first uplink grant is transmitted.

2. The first node according to claim 1, wherein whether the uplink transmission occupies the PUSCH corresponding to the second uplink grant depends on whether a PUSCH corresponding to a third uplink grant is transmitted, the third uplink grant is available for a UCI, and a UCI corresponding to the third uplink grant is used to determine whether at least the second uplink grant is not performed; the first uplink grant, the third uplink grant and the second uplink grant are configured by a same configured grant configuration, and the first signaling comprises the same configured grant configuration.

3. The first node according to claim 2, wherein the PUSCH corresponding to the first uplink grant is transmitted, and the PUSCH corresponding to the third uplink grant does not carry a UCI.

4. The first node according to claim 2, comprising:
the first receiver, receiving a second signaling, the second signaling indicating that the PUSCH corresponding to the first uplink grant is successfully received;
wherein the PUSCH corresponding to the first uplink grant is transmitted; the PUSCH corresponding to the third uplink grant does not carry a UCI.

5. The first node according to claim 1, wherein the PUSCH corresponding to the first uplink grant is not transmitted, and the PUSCH corresponding to the second uplink grant is available for the uplink transmission.

6. The first node according to claim 1, wherein the PUSCH corresponding to the first uplink grant is transmitted, and whether the uplink transmission occupies the PUSCH corresponding to the second uplink grant is at least dependent on the UCI corresponding to the first uplink grant.

7. The first node according to claim 1, comprising:
the first receiver, receiving a first indication from a lower layer of the first node, the first indication being used to determine that the PUSCH corresponding to the first uplink grant is not transmitted.

8. A second node for wireless communications, comprising:
a second transmitter, transmitting a first signaling, the first signaling configuring uplink grant, the uplink grant configured by the first signaling comprising a first uplink grant and a second uplink grant, the first uplink grant being available for a UCI (Uplink control information), a UCI corresponding to the first uplink grant being used to determine at least whether the second uplink grant is not performed, and the not performed referring to a PUSCH (Physical uplink shared channel) corresponding to an uplink grant is not transmitted; and
a second receiver, performing an uplink reception according to a configuration of the first signaling;
wherein whether the uplink reception comprises a PUSCH corresponding to the second uplink grant depends on whether a PUSCH corresponding to the first uplink grant is received.

9. The second node according to claim 8, wherein whether the uplink reception comprises the PUSCH corresponding to the second uplink grant depends on whether a PUSCH corresponding to a third uplink grant is received, the third uplink grant is available for a UCI, and a UCI corresponding to the third uplink grant is used to determine whether at least the second uplink grant is not performed; the first uplink grant, the third uplink grant and the second uplink grant are configured by a same configured grant configuration, and the first signaling comprises the same configured grant configuration.

10. The second node according to claim 9, wherein the PUSCH corresponding to the first uplink grant is received, and the PUSCH corresponding to the third uplink grant does not carry a UCI.

11. The second node according to claim 9, comprising:
the second transmitter, transmitting a second signaling, and the second signaling indicating that the PUSCH corresponding to the first uplink grant is successfully received;
wherein the PUSCH corresponding to the first uplink grant is received; the PUSCH corresponding to the third uplink grant does not carry a UCI.

12. The second node according to claim 8, wherein the PUSCH corresponding to the first uplink grant is not received, and the PUSCH corresponding to the second uplink grant is available for the uplink reception.

13. The second node according to claim 8, wherein the PUSCH corresponding to the first uplink grant is received, and whether the uplink reception comprises the PUSCH corresponding to the second uplink grant is at least dependent on the UCI corresponding to the first uplink grant.

14. A method in a first node for wireless communications, comprising:
receiving a first signaling, the first signaling being used to configure an uplink grant, the uplink grant configured by the first signaling comprising a first uplink grant and a second uplink grant, the first uplink grant being available for a UCI (Uplink control information), a UCI corresponding to the first uplink grant being used to determine at least whether the second uplink grant is not performed, and the not performed referring to a PUSCH (Physical uplink shared channel) corresponding to an uplink grant is not transmitted; and
performing uplink transmission according to the configuration of the first signaling;
wherein whether the uplink transmission occupies a PUSCH corresponding to the second uplink grant depends on whether a PUSCH corresponding to the first uplink grant is transmitted.

15. The method in a first node according to claim 14, wherein whether the uplink transmission occupies the PUSCH corresponding to the second uplink grant depends on whether a PUSCH corresponding to a third uplink grant is transmitted, the third uplink grant is available for a UCI, and a UCI corresponding to the third uplink grant is used to determine whether at least the second uplink grant is not performed; the first uplink grant, the third uplink grant and the second uplink grant are configured by a same configured grant configuration, and the first signaling comprises the same configured grant configuration.

16. The method in a first node according to claim 15, wherein the PUSCH corresponding to the first uplink grant is transmitted, and the PUSCH corresponding to the third uplink grant does not carry a UCI.

17. The method in a first node according to claim 15, comprising:
receiving a second signaling, the second signaling indicating that the PUSCH corresponding to the first uplink grant is successfully received;
wherein the PUSCH corresponding to the first uplink grant is transmitted; the PUSCH corresponding to the third uplink grant does not carry a UCI.

18. The method in a first node according to claim 14, wherein the PUSCH corresponding to the first uplink grant is not transmitted, and the PUSCH corresponding to the second uplink grant is available for the uplink transmission.

19. The method in a first node according to claim 14, wherein the PUSCH corresponding to the first uplink grant is transmitted, and whether the uplink transmission occupies the PUSCH corresponding to the second uplink grant is at least dependent on the UCI corresponding to the first uplink grant.

20. The method in a first node according to claim 14, comprising:
receiving a first indication from a lower layer of the first node, the first indication being used to determine that the PUSCH corresponding to the first uplink grant is not transmitted.
